(19) United States
(12) Patent Application Publication
(10) Pub. No.: US 2006/0120725 A1
(43) Pub. Date: Jun. 8, 2006

(54) Optical interface devices for optical communications

(76) Inventors: Steve W. Braun, Encinitas, CA (US); Henri Hodara, Dana Point, CA (US)

Correspondence Address: FISH & RICHARDSON, PC, P.O. BOX 1022, MINNEAPOLIS, MN, 55440-1022, US

(21) Appl. No.: 11/004,490

(22) Filed: Dec. 3, 2004

(51) Int. Cl. H04J 14/02

(52) U.S. Cl. 398/83

(57) ABSTRACT

Designs for optical interface in a communication node in an optical transmission line or bus of optical communication systems are described. Integrated designs are also described in integrate different components on a single chip.

### BACKGROUND

This application relates to optical devices and modules for optical communications.

Optical waveguides such as optical fiber and waveguide structures fabricated on substrates can be used to transmit, process, or both transmit and process light for a variety of applications, including optical communications based on technologies such as wavelength-division multiplexing (WDM), dense WDM (DWDM) or ultradense WDM (UWDM). Optical communication systems may use optical transmission lines or busses to form at least part of or all of optical links for transmitting information carried by light. Optical fiber may be used to construct the optical transmission lines or busses. In an optical communication system, communication nodes may be optically coupled to an optical transmission line or bus to retrieve information in received light or to send out information by light into the optical bus.

### SUMMARY

This application includes, among others, techniques and devices for providing optical interface between a communication node and an optical transmission line or bus in an optical communication system. Exemplary designs of the optical interface and the communication nodes are also described.

For example, one optical interface device includes an optical transmission line comprising a first end and a second end to carry light modulated with signals, first, second and third optical couplers, first and second optical waveguides, an optical transmitter port, an optical receiver port, and an optical filter. The first optical coupler is coupled to the first end and includes a first optical port, the first optical coupler operable to split a portion of light in the optical transmission line in a first direction directed from the first end towards the second end to export a first optical drop signal at the first optical port and operable to couple a first optical add signal received at the first optical port to the optical transmission line in a second direction opposite to the first direction. The first optical waveguide is coupled to the first optical port to receive the first optical drop signal and to send the first optical add signal into the first optical port. The second optical coupler is coupled to the second end and includes a second optical port. The second optical coupler is operable to split a portion of light in the optical transmission line in the second direction to export a second optical drop signal at the second optical port and operable to couple a second optical add signal received at the second optical port to the optical transmission line in the second direction. The second optical waveguide is coupled to the second optical port to receive the second optical drop signal and to send the second optical add signal into the second optical port. The third optical coupler couples the first and the second optical waveguides to each other to split an add optical signal into the first and the second optical add signals and split each of the first and second optical drop signals into a first portion and a second portion. The optical transmitter port is used to provide the optical add signal to the third optical coupler. The optical receiver port is used to receive from the third optical coupler the first portion of each of the first and the second optical drop signals. The optical filter is optically coupled in the optical transmission line between the first and the second optical couplers to optically block one or more selected wavelengths while transmitting other wavelengths in the transmission line.

As another example, an optical interface device includes an optical transmission line which includes a first end and a second end configured to carry optical pulses representing data packets, a first optical coupler that is coupled to the first end and includes a first optical port, and a first optical waveguide coupled to the first optical port to receive the first optical drop signal or to send the first optical add signal into the first optical port. The first optical coupler is operable to split a portion of light in the optical transmission line in a first direction directed from the first end towards the second end to export a first optical drop signal at the first optical port and operable to couple a first optical add signal received at the first optical port to the optical transmission line in a second direction opposite to the first direction.

This device also includes a second optical coupler coupled to the second end and including a second optical port, and a second optical waveguide coupled to the-second optical port to receive the second optical drop signal or to send the second optical add signal into the second optical port. The second optical coupler is operable to split a portion of light in the optical transmission line in the second direction to export a second optical drop signal at the second optical port and operable to couple a second optical add signal received at the second optical port to the optical transmission line in the second direction.

This device further includes a third optical coupler integrally formed on the substrate to couple the first and the second optical waveguides to each other to split an add optical signal into the first and the second optical add signals and split each of the first and second optical drop signals into a first portion and a second portion, at least one optical transmitter coupled to one of the first and the second waveguides to produce the optical add signal, at least one optical receiver coupled to one of the first and the second waveguides to receive the second portion of each of the first and the second optical drop signals, and a control circuit coupled to receive an output from the optical receiver and to control the optical transmitter. The control circuit is configured to trigger the optical transmitter to begin to transmit optical pulses for a new data packet to be added to the optical transmission line when the optical receiver has not begun to receive a first optical pulse from an incoming data packet after a fixed delay. The optical transmission line is configured to have an optical delay between the first and second optical couplers greater than a sum of a time for the light to travel from one of the first and second optical couplers to the optical receiver and a time for the light to travel from the optical transmitter to another one of the first and the second optical couplers, wherein the optical delay is set at a value so that the leading edge of the optical pulses of the new data packet is delayed from a trailing edge of a train of optical pulses of a received data packet by the fixed delay in the optical transmission line.

As a further example, an optical interface device can be integrated on a substrate. In this device, an optical transmission waveguide is integrally formed on the substrate and includes a first segment and a second segment that is not directly connected to the first segment. First and second optical ports are integrally formed on the substrate and are respectively connected to the first and second segments of the optical transmission waveguide to allow for connecting an optical element in the optical transmission waveguide. A first waveguide coupler is integrally formed on the substrate and is coupled to the first segment. This first optical coupler includes a first coupler port and is operable to split a portion of light in the optical transmission waveguide in a first direction directed from the first segment towards the second segment to export a first optical drop signal at the first coupler port and to couple a first optical add signal received at the first coupler port to the optical transmission waveguide in a second direction opposite to the first direction. A first optical waveguide is integrally formed on the substrate and is coupled to the first coupler port to receive the first optical drop signal or to send the first optical add signal into the first segment of the optical transmission waveguide via the first waveguide coupler. A second optical waveguide coupler is integrally formed on the substrate and is coupled to the second segment, the second optical waveguide coupler comprising a second coupler port and operable to split a portion of light in the optical transmission waveguide in the second direction to export a second optical drop signal at the second coupler port and to couple a second optical add signal received at the second coupler port to the optical transmission waveguide in the second direction. In addition, a second optical waveguide is integrally formed on the substrate and is coupled to the second coupler port to receive the second optical drop signal or to send the second optical add signal into the second segment of the optical transmission waveguide via the second waveguide coupler. Furthermore, this device includes a third optical coupler coupling the first and the second optical waveguides to each other to split an add optical signal into the first and the second optical add signals and split each of the first and second optical drop signals into a first portion and a second portion.

The above and other exemplary optical interface devices and associated techniques are described in detail in the attached drawings, the detailed description, and the claims.

### BRIEF DESCRIPTION OF THE DRAWINGS

FIG. 1 shows an exemplary optical interface device which provide optical coupling to an optical bus such as a waveguide or a fiber line in two directions.

FIG. 2 shows an optical interface device based on FIG. 1 with a single optical amplifier.

FIG. 3 shows an example of an optical interface device based on FIG. 1 having two or more optical amplifiers.

FIG. 4 shows a device design of the device in FIG. 2 where two open optical ports C1 and C2 are implemented for connecting an additional optical element, such as an optical filter or an optical delay element.

FIG. 6 shows an exemplary optical interface device having an optical blocking filter.

FIG. 7 shows an exemplary optical interface device having an optical delay mechanism to avoid temporal overlap between an optical pulse train for a passthrough data packet and a newly generated optical pulse train for a new data packet.

FIGS. 8A and 8B are timing charts illustrating operations of the optical interface device in FIG. 7.

FIG. 9 shows an exemplary optical interface device implementing both optical blocking filter in FIG. 6 and the optical delay in FIG. 7.

FIG. 10 shows an example of an optical interface device having three optical amplifiers.

### DETAILED DESCRIPTION

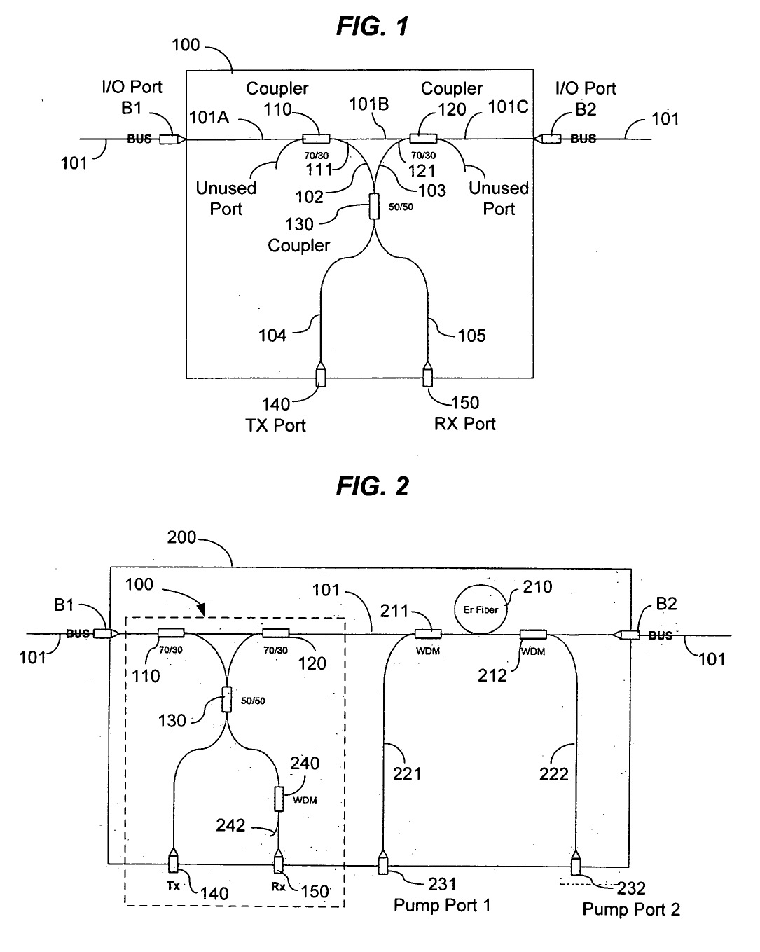

Various techniques and devices described in this application are based on an optical interface device (OID) 100 shown in FIG. 1. The OID 100 includes optical input and output ports B1 and B2 that are connected to an optical transmission line or bus 101 with segments 101A, 101B, and 101C as part of an optical communication system such as an optical fiber network. Multiple optical nodes like OID 100 are coupled to the bus 101. The port B1 in the optical bus 101 is at a first end on the left of the OID 100 and the port B1 is at a second end on the right of the OID 100. The optical transmission line 101 may be a fiber line or a waveguide fabricated on a suitable supporting member such as a substrate. When the OID 100 is implemented as an integrated chip where the waveguides in the OID 100 are planar or other waveguides formed on a substrate, the part of the transmission line 101 on the chip is a waveguide and a fiber-to-waveguide interface may be used at two ends of the waveguide to connect the waveguide 101 to a fiber line in the fiber network. The transmission line 101 carries optical pulses encoded with information, such as analog data (e.g., RF video signals) or digital data. For example, data packets may be sent in form of optical pulses in the transmission line 101. Each packet is represented by a sequence of optical pulses to carry the overhead information and the actual data. The OID 100 may be part of a communication node in an optical network to receive data from the network or to send out data to the network.

The OID 100 in the illustrated example includes a first optical coupler 110 coupled to the first segment 101A of the transmission line 101 near the first end and a second optical coupler 120 to the second segment 101C of the transmission line 101 near the second end. Each coupler may be a broadband coupler or a wavelength selective coupler such as a WDM coupler. The coupler 110 includes a first optical port 111 for dropping an optical signal from the transmission line 101 or adding an optical signal to the transmission line 101. The first optical coupler 110 operates to split a portion of light in the optical transmission line 101 in a first direction directed from the first end towards the second end to export a first optical drop signal at the first optical port 111 and is also operable to couple a first optical add signal received at the first optical port 111 to the optical transmission line 101 in a second direction opposite to the first direction.

Similarly, the second optical coupler 120 coupled to the segment 101C at the second end includes a second optical port 121 for dropping an optical signal from the transmission line 101 or adding an optical signal to the transmission line 101. The second optical coupler 120 is operable to split a portion of light in the optical transmission line 101 in the second direction to export a second optical drop signal at the second optical port 121. In addition, the second optical coupler 120 is operable to couple a second optical add signal received at the second optical port 121 to the optical transmission line 101 in the second direction.

Therefore, the use of the two couplers 110 and 120 in the above described configuration allows the OID 100 to add or insert a new signal or to drop a signal in either or both of the two directions in the transmission line 101. As such, the OID 100 may be used to provide a bi-directional optical transport system. As descried in the following sections, the OID 100 may be used as a building block to add various features for optical communications, such as power control of the optical signals, wavelength-selective blocking and adding of optical channels, protocol-independent operations, and non-blocking, multi-channel transmission features in an optical transport system.

Each optical coupler may be implemented as a 4-port coupler, such as waveguide coupler joining two waveguides on a substrate or a fiber coupler joining two fibers. All or only part of the 4 ports of each coupler are used. The couplers 110 and 120 may only be coupled at three of their 4 ports for adding and dropping signals. As described below, the third port in either of the couplers 110 and 120 may be used for, e.g., monitoring one or more signals in the bus 101 by coupling to an optical detector. The OID 100 in FIG. 1 includes a first optical waveguide 102 coupled to the first optical port 111 of the first coupler 110 to receive the first optical drop signal or to send the first optical add signal into the first optical port 111. Symmetric to the first optical waveguide 102, a second optical waveguide 103 is coupled to the second optical port 121 of the coupler 120 to receive the second optical drop signal or to send the second optical add signal into the second optical port 121. The third coupler 130 is further coupled to waveguides 104 and 105, respectively, to split light from the waveguide 104 into the waveguides 102 and 103 and to couple light from either of the waveguides 102 and 103 into the waveguides 104 and 105. The end of the waveguide 104 is terminated at a transmitter port 140 (Tx port) which is connected to at least one optical transmitter. The end of the waveguide 105 is terminated at a receiver port 150 (Rx port) which is connected to at least one optical receiver.

In one implementation, the waveguides 102 and 104 may be two different portions of the same waveguide and the waveguides 103 and 105 may be two different portions of another waveguide. The third optical coupler 130 couples the two waveguides to each other to optically couple a portion of light in one waveguide into another waveguide of the two waveguides so that light in the waveguide 104 received from the Rx port 140, after passing the third optical coupler 130, is split into the first and the second optical add signals in opposite directions in the bus 101. Either of the first and second optical drop signals exiting the ports 111 and 121, respectively, after passing the third optical coupler 130, is split into a first portion in the first waveguide 104 and a second portion in the second waveguide 105. Hence, the couplers 110, 120, and 130 are used as a combination to provide the dual directional add/drop capabilities of the OID 100.

Due to presence of the third optical coupler 130, the output signal from the transmitter port 140 is split into two parts that are respectively added via the couplers 110 and 120 to the transmission line 101 in two opposite directions, respectively. The third optical coupler 130 also allows a drop signal from either or both of the couplers 110 and 120 to be received by the optical receiver at the Rx port 150.

The transmitter coupled to the transmitter port 140 may be a tunable optical transmitter to produce various WDM wavelengths. The optical receiver at the Rx port 150 may include an optical filter for selecting a desired WDM wavelength and an optical detector for detecting the optically filtered signal from the filter. The optical filter may be a fixed bandpass filter at a selected WDM wavelength or a tunable filter to select any desired WDM wavelength to be received by the optical detector.

The above OID 100 in FIG. 1 lacks an optical amplification mechanism and hence inherent optical losses occurred in the OID 100 are not compensated for. As an example, each of the optical couplers 110 and 120 may have 4 optical ports where one port is not used in this particular design. Optical energy coupled into this unused port, therefore, is part of the optical losses in the OID 100. As another example, the 4-port coupler 130 also induces optical loss to an optical drop signal received by the optical receiver port 150 because a portion of the drop signal (e.g., 50%) is coupled to the other waveguide 102 that is coupled to the transmitter port 140. Therefore, the power of an optical signal in the bus 101 is reduced each time the optical signal passes through an OID 100 and only a portion of the received signal by each OID 100. As a result, the number of optical nodes implementing the OID 100 in a system may be limited due to such inevitable optical loss in OID 100. The optical power restrictions caused by these and other sources of optical losses, however, may be addressed by adding optical amplification in each OID 100.

FIG. 2 illustrates one example of an optical amplifying OID 200 based on the OID 100 in FIG. 1 where an optical gain medium 210, e.g., a strand of Er or other ion doped fiber, is inserted on one side of the OID 100 in the transmission bus 101. The gain medium 210 may be optically pumped at a pump wavelength to produce a gain at the WDM signals carried by the bus 101 so as to amplify the WDM optical signals. Two wavelength-selective optical couplers 211 and 212 such as WDM couplers are coupled in the bus 101 at two sides of the gain medium 210 to optically couple pump light at the pump wavelength which is usually shorter than the wavelengths of the WDM signals in the bus 101. Two waveguides 221 and 222 are respectively coupled to the couplers 211 and 212 to deliver pump light to the gain medium 210 and to extract transmitted pump light out of the bus 101. The waveguides 221 and 222 are respectively terminated at two pump ports 231 and 232 which are used to couple the pump light into the OID 200 and a part of used pump light out of the OID 200. For example, the optical port 232 in the waveguide 222 may be used to receive light from a pump source and the port 231 in the waveguide 221 may be used to export the unused pump light. The optical gain produced by the gain medium 210 may be made adjustable by, for example, controlling the optical pump power. In operation of the OID 200, the gain in the optical gain medium 210 may be controlled, for example, to compensate for the optical losses in the module 100 within the device 200 so that the output signal strength from each OID 200 on the bus 101 is maintained at an acceptable level.

Various optical gain media may be used to implement optical amplifiers described in this application. Doped fiber gain materials may include phosphate glass materials and other glass materials doped with rare earth ions such as Er ions. Various amplifier waveguides may also be used to form such optical amplifiers including various multicomponent glass materials. Erbium doped fiber may be replaced by erbium doped glass waveguides (as for example made by InPlane Photonics in South Plainfield, N.J.). Optical amplifiers may also use polymer waveguides doped with erbium or other rare earth materials. Semiconductors may also be used for the optical amplifiers that can have optical gain and support optical waveguides. For glass and polymer waveguides, a choice of rare-earth dopant allows optimizing the amplifier for different spectral regions. Furthermore, the amplifiers may be doped by more than one rare-earth or other dopant to achieve amplification over a broader spectral region. The optical amplifiers fabricated in some glass waveguides and polymers can be doped at a very high level of rare earth ions thus allowing large amplifier gain over a smaller distance than can be achieved with optical fiber. In addition, the waveguide amplifiers with suitable choice of index of refraction for the waveguide core and cladding materials may have a very small radius of curvature allowing serpentine structures that can be developed within a small region of a substrate. This allows smaller device volumes and facilitates device integration.

The pump coupling by the WDM couplers 211 and 212 may leave residual pump light in the bus 101. The residual pump light may be coupled by either the coupler 110 or 120 to the Rx port 150 in another OID 200 connected to the bus 101 unless the couplers 110 and 120 are designed to only split a portion of light at WDM signal wavelengths and transmits entirety of the light at the pump wavelength. When the residual pump is coupled into the Rx port 150, e.g., when the couplers 110 and 120 are broadband couplers that cover both the WDM signal wavelengths and the pump wavelength, the power of the residual pump may adversely affect the signal detection by the optical receiver coupled to the Rx port 150, e.g., saturating the optical receiver. Hence, it is desirable to remove or reduce the amount of the residual pump that reaches the Rx port 150. In one implementation, a WDM coupler 240 designed to selectively couple light at the pump wavelength to a light dump port 242 may be coupled to the optical waveguide terminated at the Rx port 150 to reduce the pump light at the Rx port 150. Alternatively, an optical filter that transmits the WDM signal wavelengths and rejects the pump light be placed between the Rx port 150 and the optical receiver to prevent the pump light from entering the optical receiver.

The above OID designs shown in FIGS. 1 and 2 may be used to construct various optical interface devices. Examples of such devices are described below.

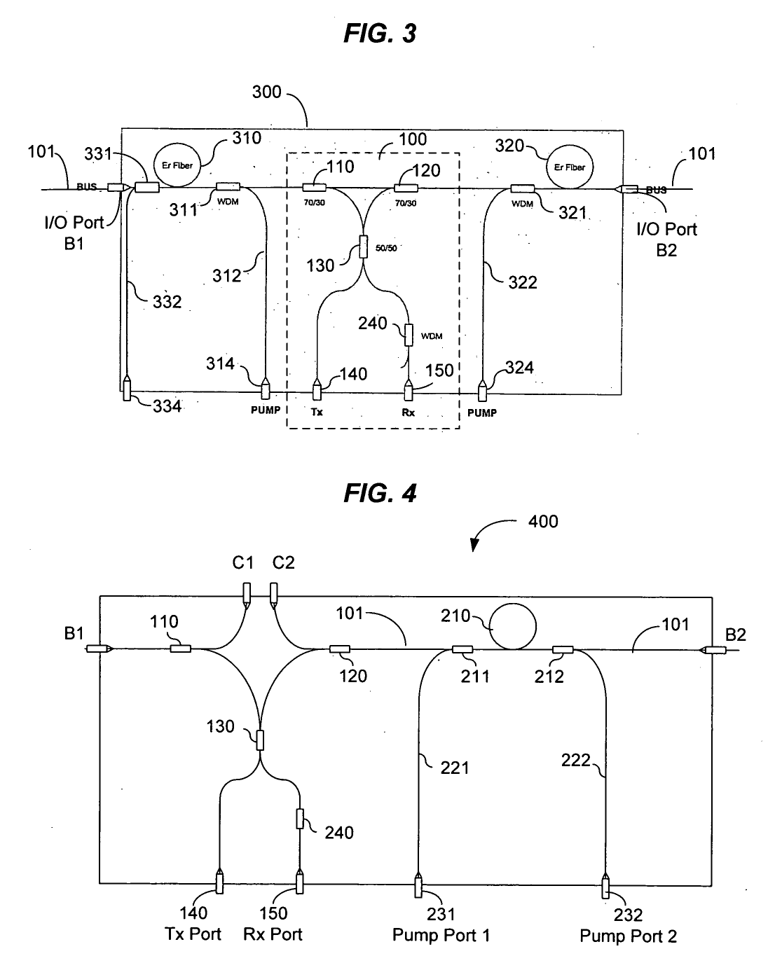

FIG. 3 shows an OID device 300 having two optical amplifiers 310 and 320 in the transmission but 101 at both sides of the OID device 100. Two wavelength-selective pump optical couplers, 311 and 321, may be coupled to the transmission line 101 to couple pump light at the pump wavelength into the optical amplifiers 310 and 320, respectively. Waveguides 312 and 322 may be coupled to the couplers 311 and 321, respectively, to supply the pump light to the respective amplifiers 310 and 320. Two pump ports 314 and 324 connected to the waveguides 312 and 322 are used to supply the pump light. As an option, a second pump coupler 331 and a waveguide 332 may be coupled to the bus 101 on the opposite side of the pump coupler 311 to remove unused pump light from the bus 101. This is similar to the pump scheme in FIG. 2 and may also be implemented for the amplifier 320. This use of two separate optical amplifiers at both ends of the OID 100 allows for improved dynamic range for controlling the optical power received by the OID 100 and optical power output by the OID 100.

In the OID 300, the optical amplifier gains for the two amplifiers 310 and 320 may be set approximately equal. The couplers 311 and 321 may then be adjusted to yield unity gain (zero insertion loss and zero removal loss) across the pass-thru and tapped-off paths. Alternatively, the gains of the two amplifiers 310 and 320 may be adjusted to achieve this unity gain condition. These implementations produce a large dynamic range for a given transmitter power and receiver sensitivity. The OID mechanization efficiencies and the increased noise floor of the cascaded optical amplifiers (2 through-path optical amplifiers per OID) may limit the maximum number of connections to a desired optical signal-to-noise ratio. In the two-amplifier OID design shown in FIG. 3, the optical amplifiers 310 and 320 may be configured so that the gain for overcoming the optical losses is less than the maximum gain of optical amplifiers 310 and 320. Under this configuration, the optical amplifiers 310 and 320 may further be used to provide a transmission signal strength gain when needed. This configuration may be particularly useful in systems that very low-level signals are sensed. The saturation level of the optical receiver to detect the transmitted signal and the increase in the amplified optical transport system noise, caused by cascaded amplifiers, set limits on the amount of gain that can be usefully employed in an Optical Transport System. To the extent that these limits are not exceeded, then transmitted signals are received at higher energy levels than the energy level of the inserted signal.

The above examples of OID designs in FIGS. 1-3 may be used as building blocks to form various functional optical modules in optical communication systems. In different applications, the same OID design may be adapted in different forms in actual applications. For example, the segment in the optical bus 101 between the couplers 110 and 120 may include an optical filter in some communication systems but an optical delay element in other communication systems. In order to adapt the same integrated OID chip design for these and other different applications, the OID designs in FIGS. 1-3 may include optical ports in the optical bus 101 between the couplers 110 and 120.

FIG. 4 illustrates an example of such a versatile OID design 400 based on the OID shown in FIG. 2. The optical bus 101 between the couplers 110 and 120 is broken into two separate waveguide segments that are terminated at two optical ports C1 and C2, respectively. Hence, an additional optical element, e.g., an optical filter or an optical delay element, may be optically coupled between the ports C1 and C2 to configure the same OID chip into different configurations. Otherwise, the ports C1 and C2 may directly connected. Similarly, OIDs in FIGS. 1 and 3 may be designed to have the ports C1 and C2. This built-in flexibility in an OID chip can reduce cost and allow for versatile applications of the same OID chip.

FIG. 5 shows one example of an OID chip design 500 on a single substrate 501 based on FIG. 4. A substrate 501 is fabricated to support optical waveguides with various optical elements for the OID in FIG. 4, including optical couplers and one or more optical gain media. All optical ports, such as input and output ports B1, B2, the Tx port 140, the Rx port 150, pump ports 231 and 232, and the ports C1 and C2, are shown to be located on one side of the substrate 501. Waveguides that are connected to the optical ports are arranged to be parallel to one another on the substrate 501. Two waveguides that are optically coupled together by an optical coupler are arranged to be adjacent to each other. In the example illustrated, the device has a dimension of less than 5 cm×3 cm but may be implemented in various sizes suitable for the specific applications.

In optical communication systems, each communication node implementing an OID described in this application may be used to add data to the systems at a selected WDM wavelength. When a new data signal is added by a node at a selected WDM wavelength, this same WDM wavelength cannot be used for other data in optical signals passing through the same node. If there is a vacant WDM wavelength available in the system, the node may transmit the new data at that available WDM wavelength and to add the new data signal at the available WDM wavelength to other signals at different WDM wavelengths. However, WDM wavelengths are scarce and valuable resource in WDM systems. In certain WDM systems, one or more WDM wavelengths used for transmitting data may be selectively blocked within a node, e.g., the data on a WDM channel is dropped is not needed for other nodes, and may be used by the same node or another node to generate one or more new optical signals at the blocked WDM wavelengths for transmission new data channels in the WDM systems. This optical blocking mechanism allows for reuse of certain WDM wavelengths.

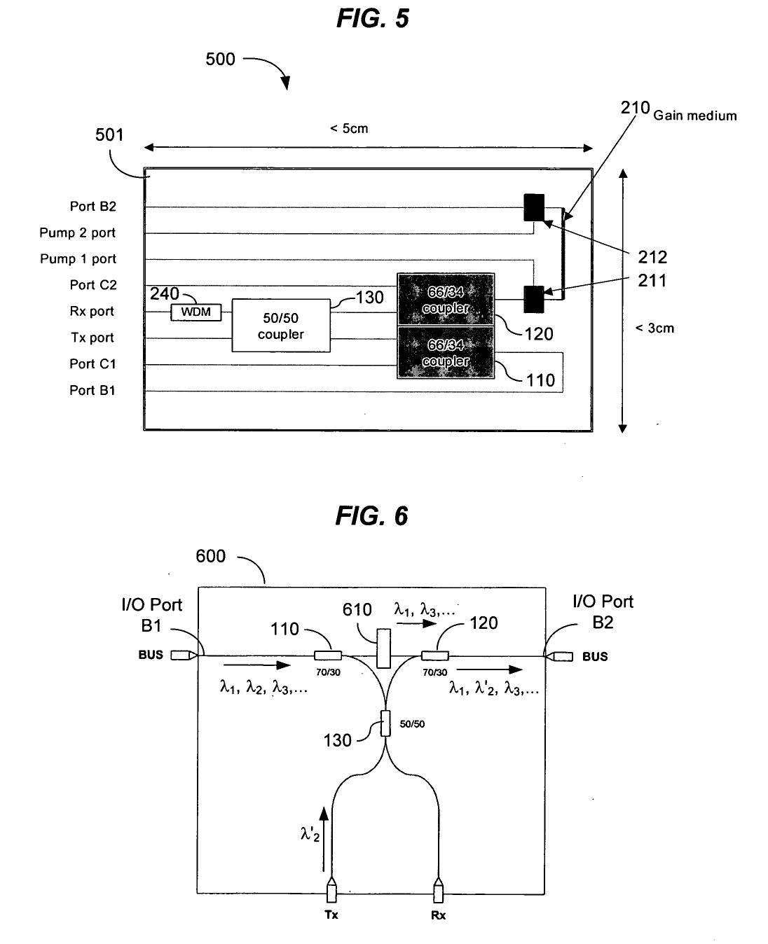

FIG. 6 shows one example of an OID 600 that uses a wavelength-selective optical filter 610 in the transmission line 101 between the couplers 110 and 120. The optical filter 610 is designed to block one or more WDM wavelengths while transmitting other WDM wavelengths. The blocked one or more WDM wavelengths are received by the receiver port 150 through the optical coupler 110 or 120 depending on the direction of the incoming signals and the third coupler 130. Since the blocked one or more WDM wavelengths are removed from the transmission line 101 by the filter 610, the transmitter at the Tx port 140 may be used to generate new optical signals at the same one or more blocked WDM wavelengths in the output of the OID 600. Notably, the optical filter 610 is located between the couplers 110 and 120, a new signal generated by the transmitter 140 does not pass the filter 510 in both directions and thus is sent out in both directions in the transmission line 101. As illustrated, the OID 600 receives signals from the left port B1 with WDM channels at λ1, λ2, λ3, . . . The filter 610 blocks the channel at λ2 but transmits all other WDM channels at λ1, λ3 . . . Hence, the WDM channel at λ2 is received at the Rx port 150 and is terminated by the filter 610. If the node 600 needs to add a new WDM channel, the same wavelength λ2 may be used by the transmitter coupled to the Tx port 140. The new WDM channel may be represented by λ2 with different data channel from the original channel at λ2. Alternatively, the blocked wavelength λ2 may be used to send a new WDM channel by another node.

In the above and other OID designs based on the design in FIG. 1, each node based on an OID may add data to the optical bus 101. The data is transmitted in units of data packets. When adding a new data packet, each node faces a decision as to when to transmit the new data packet after receiving an incoming data packet. In many optical systems for transmitting data packets, each data packet is represented by a train of sequential optical pulses and each node may not have the priori knowledge about arrival of a new data packet. Without the certainty in knowing when the optical pulses for the next data packet will arrive, a node may transmit optical pulses for a new data packet generated at the node too early so that the pulses for the newly generated data packet overlap in time with optical pulses of a data packet that passes through the node but begin to arrive the node before the new data packet leaves the current node. This temporal overlap or “collision” between a pass-through data packet in the optical bus and the newly-generated data packet is undesirable and should be avoided because it can lead to loss of data.

In this regard, a technique is described here to avoid above uncertainty and the associated adverse overlap between data packets. This technique is based on two operating conditions. First, a pass-through data packet is optically delayed within each node between the couplers 110 and 120 and this delay is used to control the beginning of transmission of a new data packet from the node to have a fixed time delay ΔT at the end of a pass-through data packet. Second, only one of nodes on the optical bus 101 adds a new data packet to the bus 101 at one time and different nodes add their respective new data packets at different times. Under the above operating conditions, each node can be controlled to wait for a period δt longer than ΔT to transmit a new data packet without compromising the throughput of each node and avoids the overlap between the new data packet and a pass-through data packet.

In operation, the communication system initializes the nodes on the bus 101 to begin transmission of packets by various nodes. For example, during the system initialization or a system failure, nodes may be controlled to automatically transmit a special packet if no transmissions are received within a given time period. Receipt of this packet causes all other nodes to respond with their own transmission.

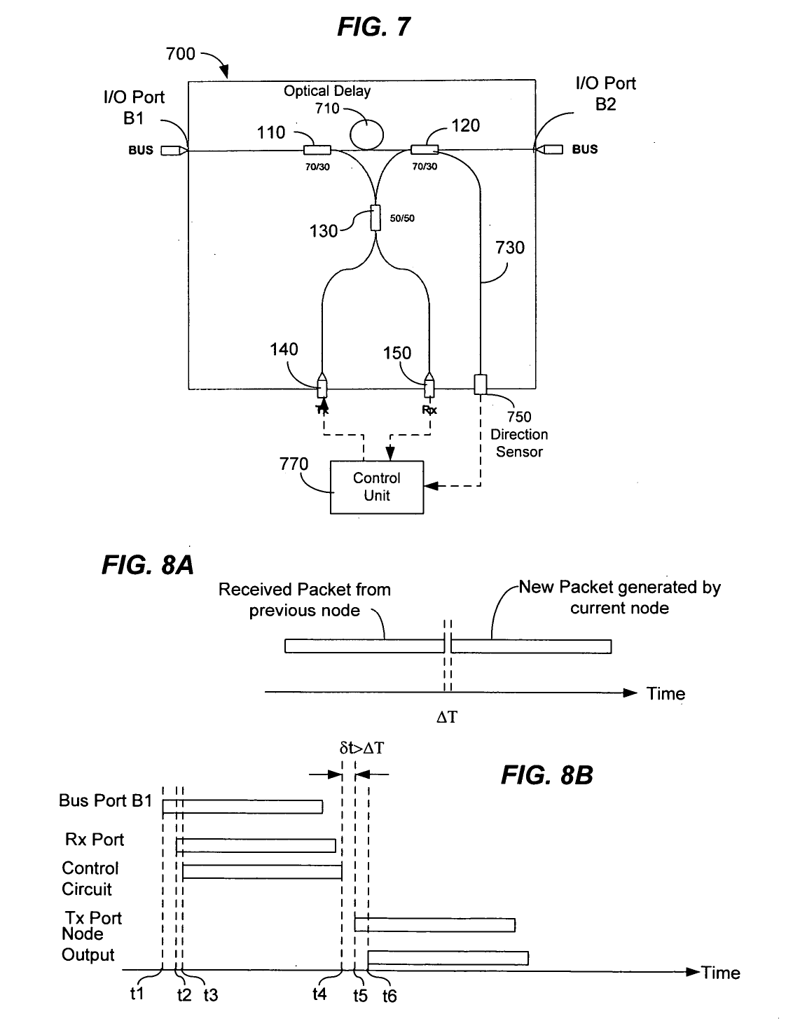

FIG. 7 illustrates an OID 700 implementing an optical delay 710 between the couplers 110 and 120 based on the design in FIG. 1. A control unit 770 is implemented to receive the output from the optical receiver coupled to the Rx port 150 and to control the optical transmitter coupled to the Tx port 140. An additional waveguide 730 may be coupled to one of the couplers 110 and 120 to supply a monitor beam to an optical sensor 750 as the directional sensor for sensing the propagation direction of a data packet in the optical bus 101. The control unit 770 is designed to process optical pulses received in the optical receiver port 150, and to trigger the optical transmitter at the Tx port 140 to begin to transmit optical pulses for a new data packet to be added to the optical bus 101. The optical delay loop 610 and the control circuit 630 in combination form the mechanism for avoiding the packet overlap based on the optical delay.

FIGS. 8A and FIG. 8B are timing charts to illustrate the operation of the OID 700 with the optical delay 710 and the control unit 770. FIG. 8A shows the timing of a pass-through data packet and a newly added data packet at the output of the node where the beginning of the newly generated data packet is delayed by ΔT from the tail of the pass-through data packet. A node may not transmit a new data packet after it receives a data packet from the bus 101 but if the node does transmit, the transmission is controlled as shown in FIG. 8A. All nodes on the bus 101 act in this way so that each node, after a period ΔT at the end of a pass-through data packet, knows for a certainty that whether this is a subsequent data packet following the received data packet. This is because the next data packet, if exists, must begin to arrive after the time ΔT. Otherwise, there will not be a subsequent data packet. Hence, in order to add a new data packet, the node waits for a time ΔT when a subsequent data packet does not appear after the time ΔT lapses and begins to transmit its new data packet after a time δt>ΔT from the tail of the received packet.

Referring to FIG. 8B, the leading edge of a data packet with a packet length T_{D1} in the bus 101 is shown to arrive at the coupler 110 of the OID 700 at time t1. Due to the optical transmission through the couplers 110 and 130 via the waveguides 102 and 105, the leading edge arrives at the Rx port 150 at a later time t2. The control unit 770 learns of the arrival of the data packet at time t3 when the leading edge of the optical pulse train reaches the Rx port 150 and the control unit 770 processes the detector output from the optical receiver connected to the Rx port. This is due to the delay at the optical receiver that converts light into a detector output and the additional delay by the detection electronics in the control unit 770. At the time t4, the control unit 770 detects the tail of the received data packet. If the node does not need to transmit, the node simply processes the received packet and wait for the next packet. If the node transmits to add a new data packet with a packet length of T_{D2} to the bus 101, the node sends out the leading edge of the optical pulse train for the new packet at the Tx port 140 at time t5 due to the delay in the electronics in the control unit 770 and the delay in the optical transmitter connected to the Tx port 140. At time t6, the leading edge transmits through the internal part of the node and enters the bus 101 at the coupler 120.

Notably, the amount of the optical delay, τ, for the received packet in the bus 101 between the couplers 110 and 120 must be greater than the time for the light to travel from the coupler 110 to the Rx port 150 and plus the time for the light to travel from the Tx port 140 to the coupler 120. More specifically, the during the time (t6−t1), the optical delay T in the bus 101 between the couplers 110 and 120 must be sufficiently long to create the condition shown in FIG. 8A, i.e., to create a fixed delay ΔT between the tail of the received packet and the leading edge of the newly generated packet after the newly generated packet enters the bus 101. The optical length in the bus 101 between the couplers 110 and 120 is set to produce the desired optical delay τ. When the delay by the optical waveguide in the bus 101 between the couplers 110 and 120 is not sufficient, an optical delay element 710 may be optically coupled between the couplers 110 and 120 to introduce additional delay to produce the desired delay T. Referring back to FIG. 4, the optical delay element 710 may be coupled between the ports C1 and C2 of the OID chip 400. As an example, a fiber loop may be used as the optical delay element 710.

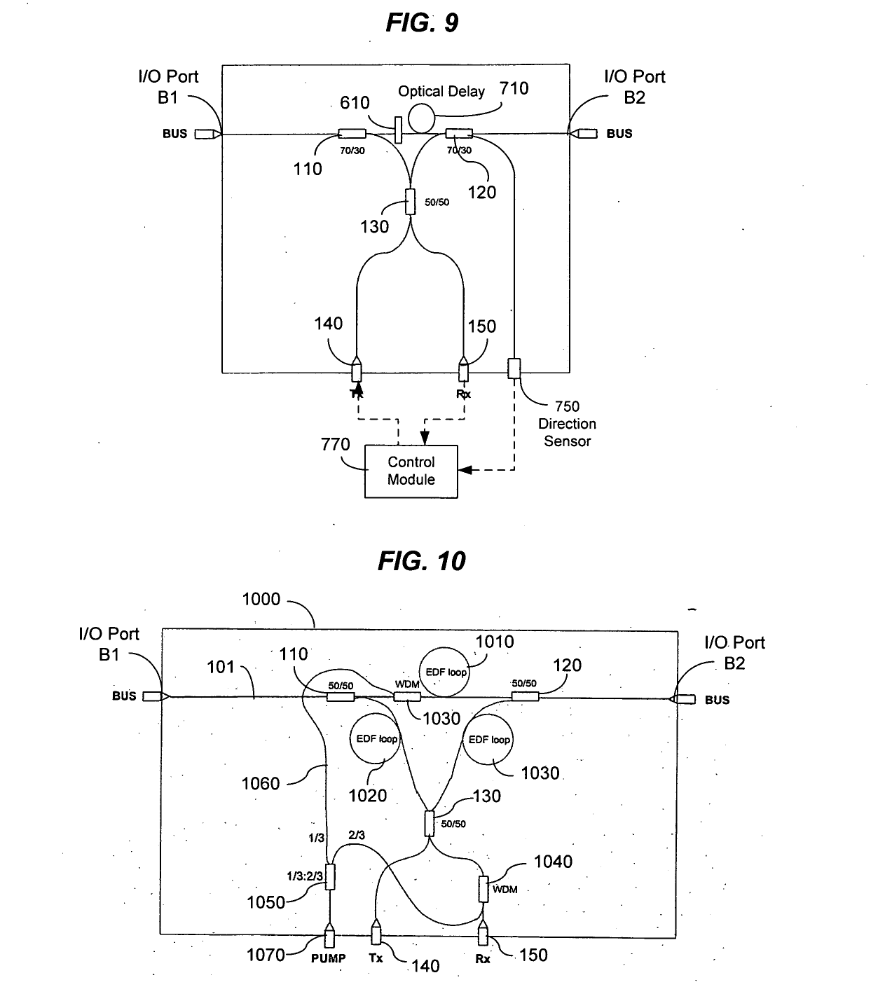

This optical delay mechanism may be combined with the optical wavelength blocking in FIG. 6. FIG. 9 shows one example of this combination. Either or both of the optical delay in FIG. 6 and the optical blocking in FIG. 5 may be combined with any of the OID designs described in FIGS. 1-4. In the versatile OID design exemplified by FIG. 4, the optical blocking filter 610 and the delay element 710 may be optically coupled in series and are connected to the ports C1 and C2.

The above OID designs may be advantageously integrated in a single chip by fabricating various optical components on the same substrate where light is confined in and directed by optical waveguides fabricated on the substrate. The integration of multiple structures within a single substrate may include waveguides, waveguide amplifiers and waveguide couplers, and other devices such as wavelength division multiplexers and wavelength division demultiplexers, optical filters, variable optical attenuators, polarization rotators, optical modulators, waveguide isolators, photodetectors and optical sources. In the integrated designs, optical filters may be formed by waveguide Bragg gratings, microresonators, arrayed waveguides or by other types of interferometric structures such as acousto-optic filters. In addition, certain control electronic circuits for the OID devices, e.g., a portion or all electronic elements in the control module 770 in FIGS. 7 and 9, may also be integrated on the same substrate with optical components.

FIG. 10 shows another exemplary OID 1000 with 3 separate optical amplifiers 1010, 1020, and 1030 that are coupled in the transmission line 101 between couplers 110 and 120, the first waveguide 102 between the coupler 110 and the coupler 130, and the second waveguide 103 between the coupler 120 and the coupler 130, respectively. A pump coupler 1030 is coupled in the transmission line between the couplers 110 and 120 to supply pump light into the optical amplifier 1010. A second pump coupler 1040 is coupled in the waveguide 103 between the coupler 130 and the receiver 150 to inject pump light into the waveguide 103. The coupler 130 splits the pump light into two pump beams into the amplifiers 1020 and 10430, respectively. As illustrated, a single pump source 1070 may be used to supply the pump light for all three amplifiers. An optical coupler 1050 may be used to split the pump light into a first pump beam for the amplifier 1010 through the pump coupler 1030 and a second pump beam for the amplifiers 1020 and 1030 through the pump coupler 1040 and the waveguide 103. In comparison with the designs in FIGS. 2-4, this 3-amplifier design provides additional flexibility and control over the power levels of optical signals in the OID 1000.

Only a few implementations are disclosed. However, various modifications, variations and enhancements may be made.

What is claimed is:

1. A device, comprising:
an optical transmission line having a first end and a second end to carry light modulated with signals;
a first optical coupler coupled to the first end and having a first optical port, the first optical coupler operable to split a portion of light in the optical transmission line in a first direction directed from the first end towards the second end to export a first optical drop signal at the first optical port and operable to couple a first optical add signal received at the first optical port to the optical transmission line in a second direction opposite to the first direction;
a first optical waveguide coupled to the first optical port to receive the first optical drop signal and to send the first optical add signal into the first optical port;
a second optical coupler coupled to the second end and comprising a second optical port, the second optical coupler operable to split a portion of light in the optical transmission line in the second direction to export a second optical drop signal at the second optical port and operable to couple a second optical add signal received at the second optical port to the optical transmission line in the second direction;
a second optical waveguide coupled to the second optical port to receive the second optical drop signal and to send the second optical add signal into the second optical port;
a third optical coupler coupling the first and the second optical waveguides to each other to split an add optical signal into the first and the second optical add signals and split each of the first and second optical drop signals into a first portion and a second portion;
an optical transmitter port to provide the optical add signal to the third optical coupler;
an optical receiver port to receive from the third optical coupler the first portion of each of the first and the second optical drop signals; and
an optical filter optically coupled in the optical transmission line between the first and the second optical couplers to optically block one or more selected wavelengths while transmitting other wavelengths in the transmission line.

2. A device as in claim 1, further comprising an optical transmitter coupled to the optical transmitter port to produce at least the optical add signal at one of the selected wavelengths blocked by the optical filter, wherein the third optical coupler directs the first and second optical add signals to the optical transmission line in both the first and the second directions via the second and the first optical couplers, respectively.

3. The device as in claim 1, wherein the optical length in the optical transmission line between the first and the second optical couplers is configured to have an optical delay greater than a sum of a time for the light to travel from one of the first and second optical couplers to the receiver port and a time for the light to travel from the transmitter port to another one of the first and the second optical couplers,
the device further comprising:
an optical transmitter coupled to the optical transmitter port to produce the optical add signal and to supply the optical add signal to the third optical coupler which splits the optical add signal into the first and second optical add signals;
an optical receiver coupled to the optical receiver port to detect the first portion of each of the first and the second optical drop signals; and
a control circuit, in communication with the optical transmitter and the optical receiver, operable to control the optical transmitter to produce a train of optical pulses for a new data packet, when the new data packet is needed, as the optical add signal whose leading edge is delayed from a trailing edge of a train of optical pulses of a received data packet by a fixed delay in the optical transmission line, and the control circuit further configured to initiate transmission of the new data packet by the optical transmitter when no optical pulses are detected at the optical receiver after the fixed delay in time has passed following a trailing edge of a last received data packet.

4. The device as in claim 1, further comprising an optical amplifier in the transmission line to optically amplify light.

5. The device as in claim 1, further comprising two optical amplifiers in the optical transmission line on two sides of the first and the second optical couplers, respectively.

6. The device as in claim 1, further comprising:
a first optical amplifier in the optical transmission line between the first and the second optical couplers;
a second optical amplifier in the first optical waveguide; and
a third optical amplifier in the second optical waveguide.

7. The device as in claim 1, further comprising:
a substrate on which the transmission line, the first and the second optical waveguides are waveguides fabricated,
wherein the first, the second, and the third optical coupler are waveguide couplers integrated on the substrate, and where the optical filter is integrated on the substrate.

8. The device as in claim 1, wherein the substrate comprises silicate and each waveguide comprises doped silicate.

9. The device as in claim 7, wherein the optical filter comprises a waveguide Bragg grating.

10. The device as in claim 7, wherein the optical filter comprises a microresonator.

11. The device as in claim 7, wherein the optical filter comprises an arrayed waveguide.

12. The device as in claim 7, wherein the optical filter comprises an interferometric structure.

13. The device as in claim 7, wherein the optical filter comprises an acousto-optic filter.

14. The device as in claim 7, further comprising an optical amplifier in a portion of a waveguide on the substrate.

15. The device as in claim 14, wherein the optical amplifier comprises a doped glass material.

16. A device, comprising:
an optical transmission line comprising a first end and a second end configured to carry optical pulses representing data packets;
a first optical coupler coupled to the first end and comprising a first optical port, the first optical coupler operable to split a portion of light in the optical transmission line in a first direction directed from the first end towards the second end to export a first optical drop signal at the first optical port and operable to couple a first optical add signal received at the first optical port to the optical transmission line in a second direction opposite to the first direction;
a first optical waveguide coupled to the first optical port to receive the first optical drop signal or to send the first optical add signal into the first optical port;
a second optical coupler coupled to the second end and comprising a second optical port, the second optical coupler operable to split a portion of light in the optical transmission line in the second direction to export a second optical drop signal at the second optical port and operable to couple a second optical add signal received at the second optical port to the optical transmission line in the second direction;
a second optical waveguide coupled to the second optical port to receive the second optical drop signal or to send the second optical add signal into the second optical port;
a third optical coupler coupling the first and the second optical waveguides to each other to split an add optical signal into the first and the second optical add signals and split each of the first and second optical drop signals into a first portion and a second portion;
at least one optical transmitter coupled to one of the first and the second waveguides to produce the optical add signal;
at least one optical receiver coupled to one of the first and the second waveguides to receive the second portion of each of the first and the second optical drop signals; and
a control circuit coupled to receive an output from the optical receiver and to control the optical transmitter, the control circuit configured to trigger the optical transmitter to begin to transmit optical pulses for a new data packet to be added to the optical transmission line when the optical receiver has not begun to receive a first optical pulse from an incoming data packet after a fixed delay,
wherein the optical transmission line is configured to have an optical delay between the first and second optical couplers greater than a sum of a time for the light to travel from one of the first and second optical couplers to the optical receiver and a time for the light to travel from the optical transmitter to another one of the first and the second optical couplers, wherein the optical delay is set at a value so that the leading edge of the optical pulses of the new data packet is delayed from a trailing edge of a train of optical pulses of a received data packet by the fixed delay in the optical transmission line.

17. The device as in claim 16, further comprising an optical filter optically coupled in the optical transmission line between the first and the second optical couplers to optically block one or more selected wavelengths while transmitting other wavelengths in the transmission line, wherein the optical transmitter is configured to produce at least the optical add signal at one of the selected wavelengths blocked by the optical filter.

18. The device as in claim 16, further comprising:
an optical amplifier coupled in the optical transmission line to optically amplify the optical pulses when optically pumped by pump light; and
first and second pump optical couplers coupled at two opposite sides of the optical amplifier, respectively, to direct the pump light into the optical amplifier and to extract residual pump light transmitted through the optical amplifier out of the optical transmission line.

19. A device, comprising:
a substrate;
an optical transmission waveguide integrally formed on the substrate, the transmission waveguide comprising a first segment and a second segment that is not directly connected to the first segment;
first and second optical ports integrally formed on the substrate and respectively connected to the first and second segments of the optical transmission waveguide to allow for connecting an optical element in the optical transmission waveguide;
a first waveguide coupler integrally formed on the substrate and coupled to the first segment, the first optical coupler comprising a first coupler port and operable to split a portion of light in the optical transmission waveguide in a first direction directed from the first segment towards the second segment to export a first optical drop signal at the first coupler port and to couple a first optical add signal received at the first coupler port to the optical transmission waveguide in a second direction opposite to the first direction;
a first optical waveguide integrally formed on the substrate and coupled to the first coupler port to receive the first optical drop signal or to send the first optical add signal into the first segment of the optical transmission waveguide via the first waveguide coupler;
a second optical waveguide coupler integrally formed on the substrate and coupled to the second segment, the second optical waveguide coupler comprising a second coupler port and operable to split a portion of light in the optical transmission waveguide in the second direction to export a second optical drop signal at the second coupler port and to couple a second optical add signal received at the second coupler port to the optical transmission waveguide in the second direction;
a second optical waveguide integrally formed on the substrate and coupled to the second coupler port to receive the second optical drop signal or to send the second optical add signal into the second segment of the optical transmission waveguide via the second waveguide coupler; and
a third optical coupler integrally formed on the substrate to couple the first and the second optical waveguides to each other to split an add optical signal into the first and the second optical add signals and split each of the first and second optical drop signals into a first portion and a second portion.

20. The device as in claim 19, further comprising an optical filter connected between the first and second optical ports of the optical transmission waveguide to reject one or more selected wavelengths while transmitting other wavelengths in the optical transmission waveguide.

21. The device as in claim 20, further comprising an optical transmitter to produce at least the optical add signal at one of the selected wavelengths blocked by the optical filter.

22. The device as in claim 20, further comprising an optical delay element optically coupled in series with the optical filter between the first and the second optical ports.

23. The device as in claim 22, further comprising:
an optical transmitter to produce the optical add signal and to supply the optical add signal to the third optical coupler which splits the optical add signal into the first and second optical add signals;
an optical receiver to detect the first portion of each of the first and the second optical drop signals,
wherein the optical delay element is configured to have an optical delay greater than a sum of a time for the light to travel from one of the first and second optical couplers to the optical receiver and a time for the light to travel from the optical transmitter to another one of the first and the second optical couplers; and
a control circuit, in communication with the optical transmitter and the optical receiver, operable to control the optical transmitter to produce a train of optical pulses for a new data packet, when the new data packet is needed, as the optical add signal whose leading edge is delayed from a trailing edge of a train of optical pulses of a received data packet by a fixed delay in the optical transmission line, and the control circuit further configured to initiate transmission of the new data packet by the optical transmitter when no optical pulses are detected at the optical receiver after the fixed delay in time has passed following a trailing edge of a last received data packet.

24. The device as in claim 22, further comprising:
an optical delay element connected between the first and second optical ports of the optical transmission waveguide to cause an optical delay in the optical transmission waveguide;
an optical transmitter to produce the optical add signal and to supply the optical add signal to the third optical coupler which splits the optical add signal into the first and second optical add signals;
an optical receiver to detect the first portion of each of the first and the second optical drop signals,
wherein the optical delay element is configured to make the optical delay greater than a sum of a time for the light to travel from one of the first and second optical couplers to the optical receiver and a time for the light to travel from the optical transmitter to another one of the first and the second optical couplers; and
a control circuit, in communication with the optical transmitter and the optical receiver, operable to control the optical transmitter to produce a train of optical pulses for a new data packet, when the new data packet is needed, as the optical add signal whose leading edge is delayed from a trailing edge of a train of optical pulses of a received data packet by a fixed delay in the optical transmission line, and the control circuit further configured to initiate transmission of the new data packet by the optical transmitter when no optical pulses are detected at the optical receiver after the fixed delay in time has passed following a trailing edge of a last received data packet.

25. The device as in claim 20, further comprising:
an optical amplifier coupled in the optical transmission waveguide to optically amplify the optical pulses when optically pumped by pump light; and
first and second pump optical couplers coupled at two opposite sides of the optical amplifier, respectively, to direct the pump light into the optical amplifier and to extract residual pump light transmitted through the optical amplifier out of the optical transmission waveguide.
